(19) United States
(12) Patent Application Publication
(10) Pub. No.: US 2010/0100869 A1
(43) Pub. Date: Apr. 22, 2010

(54) Method of Creating an Application That Provides for the Specifying of a New Menu Item in a Context Sensitive Menu

(76) Inventors: Nedim Fresko, Redwood City, CA (US); Timothy Neil, Mississauga (CA); Rowell Cruz, Mississauga (CA); Ramprabhu Jayaraman, Highland Park, NJ (US)

Correspondence Address: Eckert Seamans Cherin & Mellott, LLC, 600 Grant Street, 44th Floor, Pittsburgh, PA, 15219, US

(21) Appl. No.: 12/493,350

(22) Filed: Jun. 29, 2009

Related U.S. Application Data
(60) Provisional application No. 61/106,591, filed on Oct. 19, 2008.

(51) Int. Cl. G06F 9/44; G06F 9/45

(52) U.S. Cl. 717/109; 717/140

(57) ABSTRACT

An improved application development tool enables the creation of an application and provides for the creation of additional context-sensitive menu items.

### CROSS-REFERENCE TO RELATED APPLICATION

The instant application claims priority from U.S. Provisional Patent Application Ser. No. 61/106,591 filed Oct. 19, 2008, the disclosures of which are incorporated herein by reference.

### BACKGROUND

1. Field

The disclosed concept relates generally to application development and, more particularly, to a method of creating an application wherein a number of preexisting instruction sets and a number of configurable parameters can be dynamically employed to create an additional menu item in a context-sensitive menu of an application.

2. Description of the Related Art

Many applications are developed using markup language such as html and scripting instructions such as JavaScript, by way of example. Such applications typically are executed in an instance of a browser on an electronic device since the browser is capable of rendering the html content and usually is capable of executing the JavaScript instructions. It is noted, however, that the instance of the browser that performs these operations typically itself runs in a different environment, such as a Java runtime, by way of example.

Since browsers typically are used for rendering html and executing JavaScript that has been received on an electronic device as content via a network such as the worldwide web, and since the potential for receiving malicious code always exists, browsers oftentimes are configured to execute such received content at a high level of security and thus with a consequent low level of functionality. That is, browsers oftentimes are configured to permit at most very limited types of operations when compared with the quantity and level of sophistication of the operations that could be executed in, for instance, a Java runtime. Unfortunately, however, the quantity of application developers having a good working knowledge of Java application programming is relatively small compared with the number of web developers skilled with html and JavaScript. It thus would be desirable in some fashion to facilitate the development of applications providing sophisticated functionality.

### BRIEF DESCRIPTION OF THE DRAWINGS

A full understanding of the disclosed concept can be obtained from the following Description when read in conjunction with the accompanying drawings in which:

FIG. 1 depicts in a schematic fashion an exemplary environment for application development and data processing;

FIG. 2 is an example screen of a user interface of an improved tool for creating applications;

FIG. 3 is another example screen from the user interface;

FIG. 4 is a diagram depicting the dynamic development of an application using a number of configurable parameters and template instruction sets;

FIG. 5 is an example of an output on a display of an electronic device;

FIG. 6 is another example of an output on the display of the electronic device;

FIG. 7 is another example of an output on the display of the electronic device;

FIG. 8 is another example of an output on the display of the electronic device;

FIG. 9 is another example of an output on the display of the electronic device;

FIG. 10 is another example of an output on the display of the electronic device;

FIG. 11 is another example of an output on the display of the electronic device; and

FIG. 12 is another example of an output on the display of the electronic device.

Similar numerals refer to similar parts throughout the specification.

### DESCRIPTION

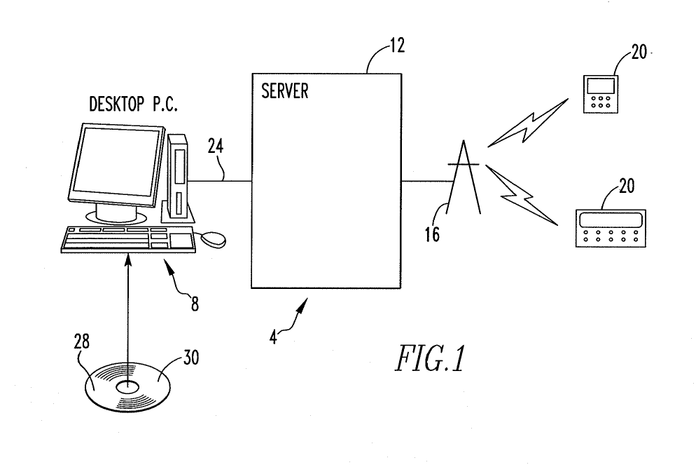

FIG. 1 can be said to depict in a schematic fashion an application development and data processing environment 4 that, for instance, comprises a desktop PC 8 and a server 12, and that further comprises a number of clients 20 that are wirelessly connected via an antenna 16 and a network 24 with the server 12, the desktop PC 8, or both. FIG. 1 also depicts a CD ROM 28 that is receivable on the desktop PC 8. The CD ROM 28 is in the nature of a machine-readable storage medium having stored thereon instructions which, when executed on the desktop PC 8, cause the desktop PC 8 to perform certain instructions such as some of those set forth below. Advantageously, the CD ROM 28 includes instructions that together form a software tool 30 that can be advantageously implemented on the desktop PC 8 to develop applications and to perform other operations, such as are described in greater detail below. The storage on the desktop PC 8 can likewise be in the nature of a machine readable storage medium when the instructions from the CD ROM 28 are installed or are otherwise deployed thereon, whereby the execution of the instructions on a processor of the desktop PC 8 causes the desktop PC 8 to perform certain operations.

It is understood that FIG. 1 is not intended to be limiting in any fashion, but rather is intended merely to illustrate one type of environment whereby the tool 30 could be implemented on the desktop PC 8 and to thereby enable an application to be readily developed on the desktop PC 8. Such an application could then be deployed, for instance, to the server 12, and could thereafter be installed on any one or more of a plurality of the clients 20. While the clients 20 are depicted as being wirelessly connected with the network 24, it is understood that other types of connections can be employed without departing from the present concept.

In general terms, the tool advantageously enables instructions written in, for instance, html, JavaScript, “pseudo-markup” instructions, and URL-based syntax to be employed in easily creating a Java application or an application that can be executed in another type of environment, and the applications can have highly sophisticated functions. Also advantageously, an application that can run in a Java runtime, for instance, can have individually defined security settings, and thus can be configured to perform a greater variety of functions than could an application executed, for instance, in a browser runtime. As will be further set forth below, the tool 30 also advantageously enables a user of the tool 30, such as an application developer who might use the tool 30, to employ relatively simple declarative instructions to provide additional menu items in context-based menus. Since menu operations typically are provided by a mechanism other than a browser mechanism, changes to a menu had previously required custom Java coding, but the tool 30 advantageously now enables additional menu items to be provided through the use of relatively simple declarative language that is input to the tool 30.

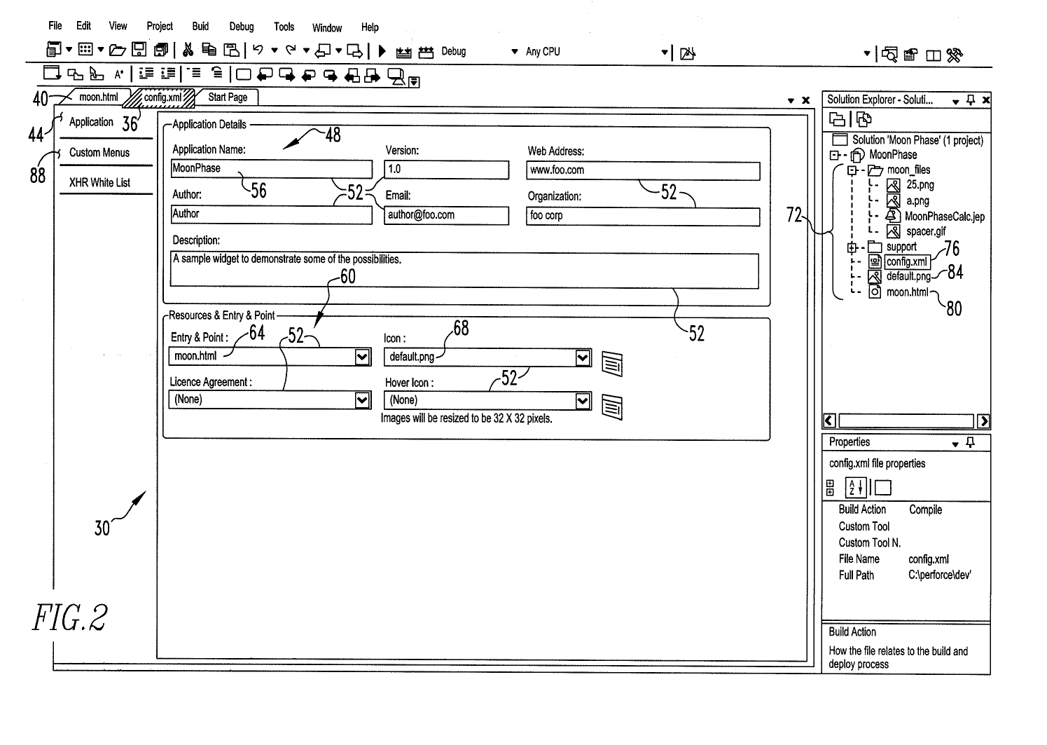

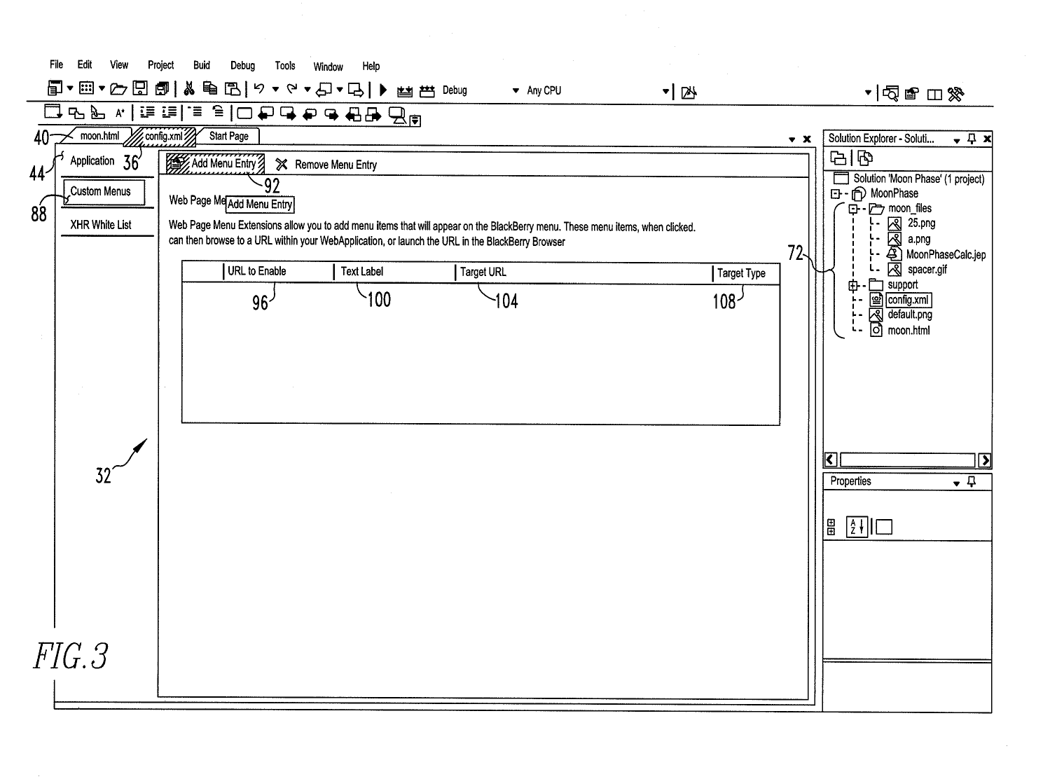

The tool 30 advantageously provides a user interface 32 that provides a number of screens, two of which are depicted in FIGS. 2 and 3. FIG. 2 depicts an exemplary config.xml tab 36 that is currently selected and that itself offers a number of other tabs, with the application tab 44 currently being selected in FIG. 2. The user interface 32 also provides an easy to use html editor that can be invoked by pressing another tab, and an example of such a tab is the moon.html tab 40 that is depicted as being adjacent config.xml tab 36.

The screen of the user interface 32 that is depicted in FIG. 2 enables a variety of configurable parameters 52 to be easily input in, for instance, an application details area 48 and a resources & entry point area 60, with the configurable parameters 52 being some of the parameters that the application developer will input into the tool 30 in order to create the desired application. For instance, the application details area 48 includes an application name field 56 into which the application developer can type or otherwise input the name that is being given to the application. Other configurable parameters 52 can be input into the other input fields depicted in the application details area 48.

The resources & entry point area 60 likewise enables a number of configurable parameters 52 to be input into labeled fields. For instance, an entry point field 64 and an icon field 68 each include a drop-down menu, although other types of fields may be employed. The convenience that is afforded by the drop-down menus is that the contents of such drop-down menus can be generated by the user interface 32 in accordance with the entries that exist in a project tree 72 that is also depicted in FIG. 2. The project tree 72 includes entries for each file or other object that is being added as a resource to the current project, i.e., the project that will result in the generation of the application that is being developed. For instance, the example name that exists in the application name field 56 is “MoonPhase”, and this is the title of the project as is indicated at the top of the project tree 72. The project tree 72 includes separate entries for each of the resources or other objects, such as a config.xml entry 76, a moon.html entry 80, and a default.png entry 84, by way of example. Additional resources and objects can be added to the project tree 72 in any of a variety of fashions such as drag-and-drop, cut and paste, and other fashions.

The drop-down menu for the icon field 68 is populated by the user interface 32 examining the project tree 72 to identify each .png file therein, and the names of each such .png file in the project tree 72 are listed as entries in the drop-down menu for the icon field 68. Thus, in the example depicted in FIG. 2, the application developer clicking the drop-down menu button would be permitted to choose from among the depicted default.png, as well as 25.png and a.png, and possibly additionally spacer.gif. The icon field 68 includes as a parameter the identity of the icon file or object that will be associated with the application once it is finalized and is available for loading onto a client 20. That is, the name listed in the icon field 68 is that of the image of the icon that will be depicted on a display of the client 20 having the final application loaded thereon. Since the application developer has loaded at least three .png files into the project tree 72, the application developer advantageously is afforded the opportunity to select from any of the .png files that have been added to the project the particular .png file that is desired to be used for the icon of the finalized application. The content of the icon field 68 thus is considered to be a configurable parameter 52 that will be employed as an input to the tool 30 when generating the finalized application.

Similarly, the entry point field 64 includes a drop-down menu which will list all of the html files that have been added to the project tree 72. In the example presented herein, only the html file “moon.html” has been added to the project tree 72, and thus the aforementioned drop-down menu for the entry point field 64 will have only a single selectable file name. The parameter in the entry point field 64 describes the name of the file that will be used as the initial page that is executed when the finalized application is invoked on the client 20. It thus likewise is another configurable parameter 52 that is used as an input to the tool 30 when generating the application.

It is noted that the configurable parameters 52 depicted generally in FIG. 2 are not the only configurable parameters 52 that are employed by the tool 30 in generating the application. That is, other tabs and other features of the tool 30 require or allow or both the input of other configurable parameters 52 that are not expressly depicted herein, it being understood that those configurable parameters 52 depicted herein are intended to convey the fashion in which values in fields can be employed by the tool 30 in creating a finalized application.

Another screen of the user interface 32 is depicted generally in FIG. 3 and, more specifically, depicts a custom menus tab 88 having been selected. This screen of the user interface 32 advantageously enables relatively simple instructions to be employed in adding menu items to context sensitive menus that are provided on the client 20 having the application executed thereon. For example, a new menu entry that is desired to be provided during execution of the application would be added, for instance, by clicking an add menu entry button 92, which would provide access to a number of fields where simple parameters would be input. For instance, a “URL to enable” field 96 would allow the application developer to input the particular web page wherein the additional menu item would appear in the context sensitive menu. For instance, and is generally known, some clients 20 provide a menu of selectable menu items that is output on a display of the client 20, for instance, in response to a predetermined input, such as an actuation of a <MENU> key on the client 20. Such menus often are context-sensitive, meaning that the particular application that is being executed will provide the “context” for determining one or more of the selectable menu items that will appear in the menu. For instance, such a menu might always have default selectable menu items such as “CUT” and “OFF” and may additionally provide menu items that are appropriate to the application. Thus, a menu item such as “create email” may appear in an email application but would not appear in a telephone application, by way of example.

As mentioned above, therefore, the “URL to enable” field 96 indicates the particular page for which the additional menu item will be provided. In the exemplary embodiment depicted herein, the allowable input in the “URL to enable” field 96 is a page of the current application or a page remote to the application, such as a page that is available via the worldwide web.

The “text label” field 100 enables the input of the label or name that will appear in the additional menu item. The “target URL” field 104 will specify in URL-based syntax the page or other resource such as a function that will be executed if the additional menu item is selected. In the exemplary embodiment depicted herein, the target URL can be another page of the same application, a page remote to the application, or a function on the page that is indicated in the “URL to enable” field 96. Such a function would typically be written as one or more JavaScript instructions on that page, although other implementations can be envisioned. The parameter received in the “target type” field 108 determines, for instance, whether the operation that will be carried out by the new menu item will appear in a new instance of the browser or will be opened within this application.

A typical menu entry operation would be as follows. In the “URL to enable” field 96, the received parameter might be “moon.html”, and the parameter received in the “text label” field 100 might be “search”. The parameter received in the “target URL” field 104 might be “www.giggle.com”. As part of the operation to convert such inputs into an additional menu item, the tool 30 converts the aforementioned inputs into URL-based syntax in the form of declarative language, and such declarative language would be added at some location to the config.xml file which, as will be set forth in greater detail below, is employed in generating the final application. An example of the declarative language that might result from this operation of the tool 30 might be

<urlenabled=“moon.html”menuentry=“search”url=“http:www.giggle.com”>

although other tags and other pseudo-markup can be employed without departing from the present concept. The result of such an operation would be that when the moon.html page is open or active on a client 20, and a predetermined input such as an actuation of a <MENU> key is detected, the menu that is output will include an additional selectable menu item entitled “search”, and a selection of this additional menu item would invoke the page http://www.giggle.com. It thus can be seen that the relatively simple parameters that were added on the screen depicted generally in FIG. 3 can be made to result in a sophisticated feature being provided.

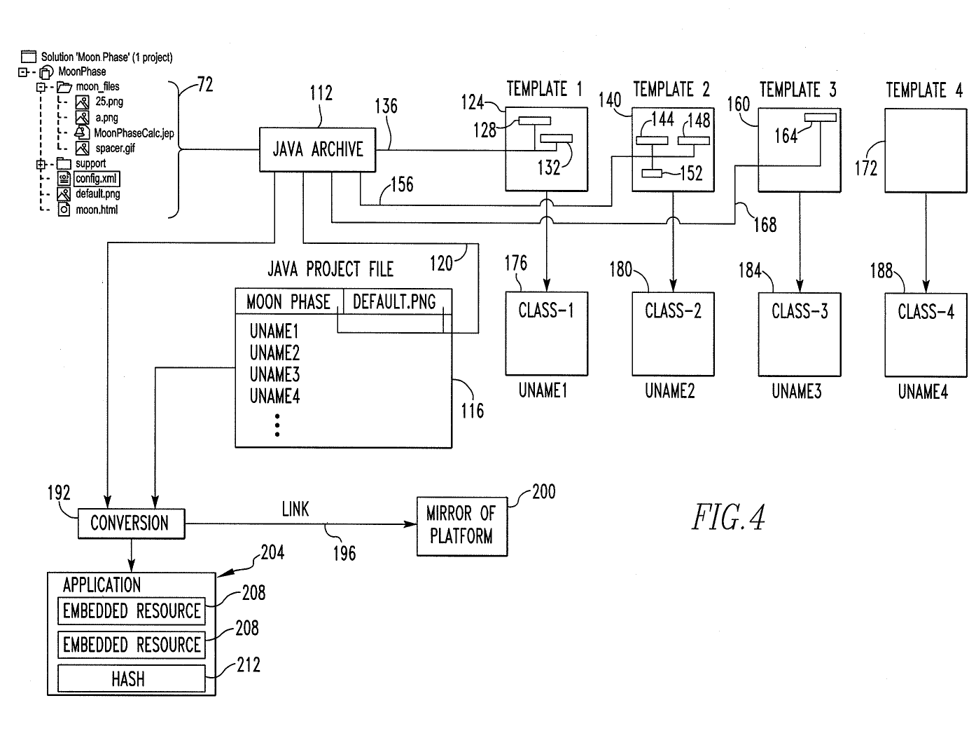

Once all of the configurable parameters 52 that are desirable or necessary or both have been input, such as with the use of the user interface 32, and all of the files, objects, or other resources that are desirable or necessary or both have been added to the project tree 72, the project is in condition for being compiled and thereby converted into an application that can be executed, for instance, in a Java runtime. Some of the operations that occur during a compiling operation are depicted generally in FIG. 4. All of the files, objects, and other resources that exist in the project tree 72 are zipped into an archive such as a Java ARchive (i.e., a JAR file). It is noted that when the new project “MoonPhase” was initiated, the config.xml was automatically created. As configurable parameters 52 were input with the user interface 32, representations of such configurable parameters 52 were added to the config.xml file. As also mentioned, the declarative language that was generated as a result of entering the parameters into the screen depicted in FIG. 3 to specify an additional menu item has been added in its declarative form to the config.xml file. Once all of the files in the project tree 72 have been zipped into the archive, such as the Java Archive 112, the configurable parameters 52 are copied from the config.xml file into a number of other files that are used by the tool 30 in generating the application.

More specifically, in the initial stages of the compiling operation, the tool 30 generates a Java project file 116 that includes certain data regarding the project such as the title of the project, i.e., “MoonPhase” and the icon being used, i.e., “default.png”, and these configurable parameters 52 are copied from the config.xml file in the Java archive 112 into the Java project file 116, as at 120. As will be set forth in greater detail below, the Java project file 116 also receives the names of other objects that are created during the compiling process.

Such other objects may be formed, for instance, from a number of template instruction sets which are in the nature of files having boilerplate Java code that will be employed in creating the application. Four such template instruction sets are depicted in an exemplary fashion in FIG. 4. Specifically, FIG. 4 depicts template-1 124, template-2 140, template-3 160, and template-4 172. In addition to the aforementioned boilerplate Java instructions, many of the template instruction sets have one or more fields that will be populated by the tool 30 with configurable parameters 52 retrieved from the config.xml file in the Java archive 112. For instance, template-1 124 is depicted as having two fields indicated at the numerals 128 and 132, and these are filled with configurable parameters 152 from the config.xml file, as indicated at the numeral 136. Template-2 140 is depicted as having three fields 144, 148, and 152 that will similarly receive configurable parameters 52, as is indicated at the numeral 156. Template-3 160 is depicted as having a single field 160 that is populated with a configurable parameter 52, as at the numeral 168. Template-four 172 is depicted as not having any fields but as still being used in the application. The distribution of the fields is likewise depicted in an exemplary fashion.

It is noted that the various fields of the template instruction sets are depicted herein as receiving configurable parameters, but other parameters, values, and the like can be employed without departing from the present concept. In populating the fields of the template instruction sets, the tool 30 employs its logic and the various configurable parameters 52 to determine which template instruction sets will be used in creating the application. While only four template instruction sets are depicted herein, it is understood that many other template instruction sets that are additional to or alternative to those shown herein may be employed and likely will vary based upon the inputs provided to the tool 30, such as via the user interface 32.

Once the fields in the template instruction sets have been filled, either with a configurable parameter or other value, the completed template instruction sets are then saved and are each advantageously given a unique name that is additionally added to the Java project file 116. As can be understood from the foregoing, the tool 30 employs its logic to identify one or more of the template instruction sets, inserts values into the fields of one or more such template instruction sets, and saves such completed template instruction sets, and all of this occurs in a dynamic fashion without express input by the web developer subsequent to initiating the compiling operation. Since each such file must be given a unique name, the tool 30 advantageously creates for each such completed template a unique name, stores the completed template under the unique name, and adds the unique name to the Java project file 116.

More specifically, the completed template instruction sets are referred to as “classes”, with each template instruction set, when populated with configurable parameters 52 and other parameters, being saved as a separate class of instructions. Each such newly saved class is assigned a unique name which, in the present example, includes both a time-based element and a random number element.

More particularly, when a given template instruction set has all of its fields populated and is in need of being saved as a new class of instructions, the tool 30 assigns to a variable <random id> a unique value by providing a current time in “ticks” and appending to the current time a random positive long number. For instance, the current time in “ticks” might be the number of milliseconds since 12:00 AM of Jan. 1, 2005. The random positive long number might be obtained in any of a variety of fashions. The class may then be uniquely identified and stored with the following exemplary namespace

net.rim.bb.backpack.package=randomid> class

where <random id> is the aforementioned integer value created by taking the time in ticks having appending to it the random positive number. It is understood that the value of <random id> can be generated in other fashions without departing from the present concept.

As each such class is created, named, and stored, the name is added to the Java project file 116. For instance, in the example of FIG. 4 the four template instruction sets 124, 140, 160, and 172 were saved as four separate classes, i.e., class-1 176, class-2 180, class-3 184, and class-4 188. For the sake of simplicity, FIG. 4 depicts the unique names as being “UNAME1”, “UNAME2”, “UNAME3”, and “UNAME4”, and these same designations are indicated, again for the sake of simplicity, as being in the project data file 116. It is reiterated, however, that the unique names assigned to each class of instructions is generated by assigning to the aforementioned variable <random id> the described time-based value to which is appended the large positive integer. It thus can be seen that as each class of instructions is dynamically formed, it is also saved in a reliable way with a unique name assigned thereto that has been created in a fashion that is extremely unlikely to result in a duplicate name.

It is also noted that a hash of one of the unique names is created and is additionally stored for future use with the final application. The hash can be of any of the unique names and is employed as a name of an area of persistence store that will be used to save certain data used by the application. For instance, if the application ultimately is a banking application, the hash might be used to indicate the area in persistence store where credit card numbers are saved. Other types of data can similarly be stored, such as answers to previously asked and answered questions, personal information, etc. without limitation.

Once all of the template instruction sets have been stored as classes with unique names and the unique names recorded in the Java project file 116, the Java project file 116 and the contents of the Java archive 112 are passed to a conversion engine that is indicated generally at the numeral 192. By way of example, all of the files, objects, or other elements that are stored in the Java archive 112, are retrieved and are passed to the conversion engine 192 and are each designated as being embedded resources. It is noted, however, that the config.xml file typically will not be provided to the conversion engine 192 as being an embedded resource since most if not all of its contents have already been used, for instance, in filling fields of template instruction sets, in providing data to the Java project file 116, or has been employed for other purposes. However, all of the other files in the Java archive 112 are passed to the conversion engine 192 for conversion into machine code.

Similarly, the conversion engine 192 parses the contents of the Java project file 116 in order to parse from it the various unique names, and such parsed unique names are employed to retrieve the classes that are saved under these unique names. The retrieved classes are passed to the conversion engine 192 and are converted, for instance, from Java code into machine code.

Once all of the classes have been converted into machine code along with the contents of the Java archive 112, a linking operation occurs, as at 192, where any instructions that ordinarily in use would import, invoke, or otherwise call a resource on a platform of a client are checked for correct linkage with a mirror 200 of the platform that is included with the tool 30. That is, many of the template instruction sets include one or more “import” statements which may be intended to cause a resource or other application on a platform to execute an operation. Since it is desired to ensure that the application will function properly on the client 20, a mirror 200 of its platform is included in the tool 30, and as part of the compiling process each such “import” or other such function is linked with the mirror 200 of the platform to ensure that it successfully describes the desired resource.

Once the linking operation, as at 196, is finished, the application, which is indicated generally at the numeral 204, is completed and is available for deployment to the server 12 or installation on one or more clients 20 or both is possible. The exemplary application 204 is depicted in FIG. 4 as comprising a number of embedded resources 208 and a hash 212 of one of the aforementioned unique names. As employed herein, the expression “a number of” and variations shall refer broadly to any nonzero quantity, including a quantity of one. The application 204 is, in the present example, in the form of compiled Java code that is executable on a Java runtime, such as one that is afforded on the platform of one of the clients 20. It is understood that the application that results from such an operation can be configured for use in environments other than Java environments without departing from the present concept.

Advantageously, and in the example presented herein, the page “moon.html” is available as one of the embedded resources 208 of the application 204, and the application 204 will cause the execution of “moon.html” by instructing the operating system of the client to create an instance of a browser, i.e., a browser having an html rendering engine and a JavaScript engine. The operating system will create the instance of the browser, and the instance of the browser will execute the html and JavaScript of “moon.html” and output can be provided accordingly. It is noted, however, that the aforementioned file “moon.html” while seemingly being executed by a browser, is actually being executed as part of a Java application and thus can have its own unique security settings and authorizations assigned thereto. Thus, moon.html could include, for instance, JavaScript that will access certain portions of the client 20 that would be unreachable if moon.html was executed in a browser runtime by the browser itself. As such, by creating the application 204 and providing the file moon.html has an embedded resource 208, the file moon.html can have a potentially greater degree of functionality on the client 20 since it is being executed in the context of a Java application. It is also noted that all of the features and functions of the application 204 were created through the use of markup language, scripting instructions, pseudo-markup language, and URL-based syntax. That is, a sophisticated Java application was created by the tool 30 despite having relatively simple inputs being provided to generate it.

The various template instruction sets available within the tool 30 can be created and organized in any of a variety of ways. For instance, a given template instruction set might be arranged to perform a specific type of operation, such as creating a new menu item when specified by the application developer. For instance, in the example set forth above regarding the inputting of a number of parameters for the creation of a new menu item and the conversion of the input parameters into a declarative pseudo-markup language, the parameters in the pseudo-markup language were stored in the config.xml file and may have been retrieved and stored in fields of a given template instruction set. Such a template instruction set may have been arranged to accept all of the instructions for all additional menu items whereby a single class of instructions having a single unique file name would have been created in order to provide the functionality to generate all of the additional menu items in the various context-sensitive menus.

An example of the advanced additional menu item feature is indicated in FIGS. 5-12. For instance, the application 204 entitled “MoonPhase” is depicted in FIG. 5 as being output on a display device 16 of a client 20 through the use of an icon 224, the application 204 being installed on the client 20 and being executable in its Java runtime. FIG. 5 depicts on the display 216 a screen 220 that is empty except for the icon 224.

FIG. 6 is the same as FIG. 5, except additionally depicting a menu 228 that displays a plurality of selectable menu items 232 on the screen 220. The generation and outputting of the menu 228 would have resulted from a detection of a predetermined input, such as the aforementioned actuation of a <MENU> key. It can be seen that the screen 220 of FIG. 5 has very little content apart from the icon 224, and thus the menu 228 of FIG. 6 has as its selectable menu items 232 a number of rather generic operations.

FIG. 7 depicts the first page that is depicted on the screen 220 when the application “MoonPhase” is first executed. In the example presented herein, the page would be that generated by the moon.html file executed as an embedded resource 208 by the application 204. In FIG. 8, a menu 228A has been rendered on the screen 220 as a result of a predetermined input. However, in the present example a new menu item 232A was specified to be available when moon.html was active, and the new menu item 232A was to be called “search”. As specified by the application developer, the new menu item 232A “search” appears in the menu 228A when the page moon.html is open or otherwise active, and in response to the predetermined input.

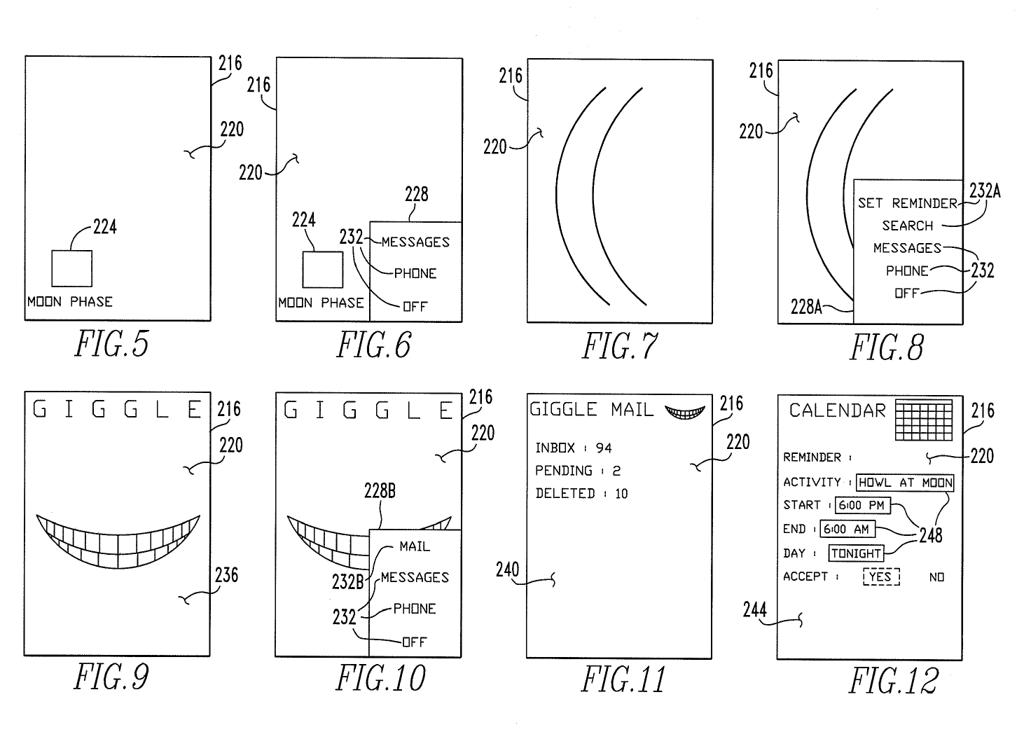

Proceeding with the same example, it will be recalled that the target URL of the additional menu item was “http:www.giggle.com”. If a selection of the new menu item 232A “search” is detected in FIG. 8, the page “www.giggle.com” is loaded on the client 20, as indicated in generally in FIG. 9. By way of further example, FIG. 10 depicts another menu 228B with another new menu item 232B “mail”. This is an example of how the application developer can specify a new menu item that will appear whenever a resource such as a page that is remote to the application is active on the display, it being assumed in this regard that www.giggle.com is remote from the application 204 “MoonPhase”. If a selection input is detected as to the new menu item 232B in FIG. 10, another remote page such as that depicted at the numeral 240 in FIG. 11 can be retrieved and output on the screen 220.

FIG. 12 depicts a scenario in which another type of new menu item is displayed, selected, and executed. More specifically, the aforementioned “target URL” parameter of a new menu item specification need not actually be a web page, but rather might be a JavaScript function that exists on a page. By way of example, the aforementioned moon.html might include a JavaScript function that includes a number of lines of JavaScript. The enabled URL would be “moon.html”, and the target URL would be the name of the aforementioned function. In the example presented in FIGS. 8 and 12, the value that had been entered into the text label field 100 was “set reminder”, and this is the text that appears for the uppermost new menu item 232A depicted in the menu 228A of FIG. 8. It may be the case that the aforementioned function that is to be executed on “moon.html” includes a number of JavaScript instruction that, when executed, automatically pre-populate a plurality of fields of a new calendar entry and open the calendar entry page to enable a user of the application to confirm whether or not the new calendar entry should be entered. Numerous other types of functions can be envisioned, it being reiterated that such a function could comprise any series of JavaScript instructions and thus be able to perform virtually any operation responsive to a selection of such a new menu item.

It thus can be seen that the improved tool 30 enables relatively sophisticated Java applications to be created without requiring actual Java coding, and rather being operable with html, JavaScript, and other simple types of inputs. The ability to execute a web page as an embedded resource of a Java application enables greater functionality by permitting customized security parameters to the application. The dynamic code creation operation also successfully assigns unique names to each new class, thus increasing the likelihood of a successful compiling operation. Also, the advanced additional menu item feature enables a web developer to make changes to a context-sensitive function, i.e., a function that typically would require Java coding, to be implemented using relatively simple inputs such as pseudo-markup and URL-based syntax, to create such additional rich functionality.

While specific embodiments of the disclosed concept have been described in detail, it will be appreciated by those skilled in the art that various modifications and alternatives to those details can be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A method of creating an application that is structured to be executed on a platform, the platform having a feature wherein a menu of selectable functions is output in response to a predetermined input, the method comprising:
receiving at least a first instruction;
incorporating at least a portion of the at least first instruction into a template instruction set to generate a class of instructions which, when executed on the platform, is structured to cause an additional selectable function that is specified at least in part by the at least first instruction to be output in the menu responsive to the predetermined input; and
compiling the class of instructions to form the at least portion of an application.

2. The method of claim 1, further comprising receiving as at least a portion of the at least first instruction an instruction to retrieve an embedded resource in the application.

3. The method of claim 1, further comprising receiving as at least a portion of the at least first instruction an instruction to retrieve a resource remote from the application.

4. The method of claim 1, further comprising receiving as at least a portion of the at least first instruction an instruction to execute a number of instructions, the number of instructions being situated within a resource and being available for execution when the resource is active on the platform.

5. The method of claim 1, further comprising receiving as at least a portion of the at least first instruction an identification of a resource and a specification of at least a portion of the additional selectable function that is to be output in the menu responsive to the predetermined input when the resource is active on the platform.

6. The method of claim 5, further comprising employing a user interface structured to receive at least one of the identification of the resource and the specification of the at least portion of the additional selectable function.

7. A machine readable storage medium having stored thereon instructions which, when executed on a processor of an electronic device, cause the electronic device perform operations to create an application that is structured to be executed on a platform, the platform having a feature wherein a menu of selectable functions is output in response to a predetermined input, the operations comprising:
receiving at least a first instruction;
incorporating at least a portion of the at least first instruction into a template instruction set to generate a class of instructions which, when executed on the platform, is structured to cause an additional selectable function that is specified at least in part by the at least first instruction to be output in the menu responsive to the predetermined input; and
compiling the class of instructions to form the at least portion of an application.

8. The machine readable storage medium of claim 7 wherein the operations further comprise receiving as at least a portion of the at least first instruction an instruction to retrieve an embedded resource in the application.

9. The machine readable storage medium of claim 7 wherein the operations further comprise receiving as at least a portion of the at least first instruction an instruction to retrieve a resource remote from the application.

10. The machine readable storage medium of claim 7 wherein the operations further comprise receiving as at least a portion of the at least first instruction an instruction to execute a number of instructions, the number of instructions being situated within a resource and being available for execution when the resource is active on the platform.

11. The machine readable storage medium of claim 7 wherein the operations further comprise receiving as at least a portion of the at least first instruction an identification of a resource and a specification of at least a portion of the additional selectable function that is to be output in the menu responsive to the predetermined input when the resource is active on the platform.

12. The machine readable storage medium of claim 11 wherein the operations further comprise employing a user interface structured to receive at least one of the identification of the resource and the specification of the at least portion of the additional selectable function.

13. An electronic device having stored thereon instructions which, when executed on a processor of the electronic device, cause the electronic device perform operations to create an application that is structured to be executed on a platform, the platform having a feature wherein a menu of selectable functions is output in response to a predetermined input, the operations comprising:
receiving at least a first instruction;
incorporating at least a portion of the at least first instruction into a template instruction set to generate a class of instructions which, when executed on the platform, is structured to cause an additional selectable function that is specified at least in part by the at least first instruction to be output in the menu responsive to the predetermined input; and
compiling the class of instructions to form the at least portion of an application.

14. The electronic device of claim 13 wherein the operations further comprise receiving as at least a portion of the at least first instruction an instruction to retrieve an embedded resource in the application.

15. The electronic device of claim 13 wherein the operations further comprise receiving as at least a portion of the at least first instruction an instruction to retrieve a resource remote from the application.

16. The electronic device of claim 13 wherein the operations further comprise receiving as at least a portion of the at least first instruction an instruction to execute a number of instructions, the number of instructions being situated within a resource and being available for execution when the resource is active on the platform.

17. The electronic device of claim 13 wherein the operations further comprise receiving as at least a portion of the at least first instruction an identification of a resource and a specification of at least a portion of the additional selectable function that is to be output in the menu responsive to the predetermined input when the resource is active on the platform.

18. The electronic device of claim 17 wherein the operations further comprise employing a user interface structured to receive at least one of the identification of the resource and the specification of the at least portion of the additional selectable function.
